(19) United States
(12) Patent Application Publication
(10) Pub. No.: US 2017/0119205 A1
(43) Pub. Date: May 4, 2017

(54) WATER FILTER ASSEMBLY WITH PROTECTIVE CHECK VALVE SCREEN

(71) Applicant: General Electric Company, Schenectady, NY (US)

(72) Inventors: Wade Antoine Powell, La Grange, KY (US); Alan Joseph Mitchell, Louisville, KY (US)

(21) Appl. No.: 14/926,188

(22) Filed: Oct. 29, 2015

(51) Int. Cl. A47J 31/60; A47J 31/46; A47J 31/40; B01D 35/157; C02F 1/00; B01D 29/56; B01D 29/15

(52) U.S. Cl. CPC A47J 31/605; B01D 29/56; A47J 31/465; B01D 29/15; B01D 35/1573; C02F 1/003; A47J 31/407; B01D 2201/291; C02F 2201/005; C02F 2307/12

(57) ABSTRACT

A water filter assembly for a beverage dispenser. The water filter assembly may generally include a one-way valve disposed in the filter housing to allow air and water to escape so that the filter cartridge may be completely saturated. The one-way valve prevents air and water from entering the filter housing from the reservoir, thereby maintaining a vacuum that prevents the water level in the filter housing from dropping along with the water level of the reservoir. Furthermore, a protective screen is placed upstream of the one-way valve to prevent the sealing surface of the valve from becoming contaminated with debris or other sediment. In this manner, the one-way valve may maintain proper sealing performance throughout the lifetime of the filter.

### FIELD OF THE INVENTION

The subject matter of the present disclosure relates generally to a water filter assembly, or more specifically, to a water filter assembly having a one-way valve protected by a valve screen.

### BACKGROUND OF THE INVENTION

Water filter assemblies are commonly used with a variety of consumer and commercial appliances to remove dirt, sediment, and other contaminants from unfiltered water sources such as, for example, municipal water supplies. These water filter systems typically receive unfiltered water through a filter inlet, filter the unfiltered water by passing it through filter media to remove contaminants and debris, and pass the filtered water out through a filter outlet to the appliance for end use.

For example, single serve beverage dispensers (SSBDs), including coffee maker appliances, utilize water for brewing and mixing operations. In order to provide single-serve beverages, SSBDs generally dispense small volumes of liquid (e.g., between eight and sixteen ounces) for each beverage. To permit consecutive preparation of beverages and decrease preparation time, certain SSBDs commonly include a removable water storage reservoir holding enough water to dispense between four and eight single-serve beverages. It is generally desirable to ensure that water stored in the reservoir is free from contaminants and other debris. Certain water filter assemblies include a filter cartridge having filter media, such as an activated carbon block, that is placed over a fluid outlet within the reservoir to filter contaminants from the water within the reservoir.

Common filter cartridges have a one-way valve that allows air trapped inside the filter housing to escape when the filter cartridge is submerged, thereby allowing the filter housing to fill completely with water. During operation of a SSBD, it is important to maintain the water level in the filter housing, even as the water level in the reservoir decreases. If the water level in the filter housing is not maintained, the SSBD may dispense less than the requested volume of water because, for example, air may be pulled into the system which prevents the correct amount of water from being dispensed.

In order to ensure that the filter housing remains full of water even when the water level in the reservoir decreases, the one-way valve acts as a seal to create a vacuum and prevent water from flowing out of the filter housing back into the reservoir. In this manner, the water level in the filter housing may be maintained even as the water level in the reservoir decreases.

However, as water and air from the unfiltered water chamber exit the filter housing through the one-way valve, debris and contaminants may be deposited on the valve sealing surface, thereby compromising the effectiveness of the seal. When the seal created by the one-way valve is broken, air or water may enter the filter housing through the one-way valve, thus breaking the vacuum and allowing water to flow out of the filter housing as the reservoir water level drops. As a result, the SSBD may dispense less than the requested volume of water and the filter cartridge must be replaced or repaired.

Accordingly, a water filter assembly that maintains the water level in the filter housing throughout the lifetime of the filter cartridge would be useful. More particularly, a water filter assembly having a one-way valve that may operate effectively for the life of a filter cartridge would be especially beneficial.

### BRIEF DESCRIPTION OF THE INVENTION

Additional aspects and advantages of the invention will be set forth in part in the following description, may be apparent from the description, or may be learned through practice of the invention.

In general, the present invention provides a water filter assembly for a beverage dispenser. The water filter assembly may generally include a one-way valve disposed in the filter housing to allow air and water to escape so that the filter cartridge may be completely saturated. The one-way valve prevents air and water from entering the filter housing from the reservoir, thereby maintaining a vacuum that prevents the water level in the filter housing from dropping along with the water level of the reservoir. Furthermore, a protective screen is placed upstream of the one-way valve to prevent the sealing surface of the valve from becoming contaminated with debris of other sediment. In this manner, the one-way valve may maintain proper sealing performance throughout the lifetime of the filter.

In one exemplary embodiment, a water filter assembly for a beverage dispenser having a reservoir is provided. The water filter assembly defines an axial direction and a radial direction and includes a filter medium extending along the axial direction and defining an interior filtered water chamber, the filter medium configured to filter water flowing inward generally along the radial direction into the interior filtered water chamber. The water filter assembly further includes a housing extending along the axial direction between a first end and a second end and enclosing the filter medium, the housing and the filter medium defining an unfiltered water chamber between the housing and the filter medium. The housing further defines an inlet in flow communication with the unfiltered water chamber proximate to the second end for receipt of unfiltered water from the reservoir, and a housing outlet in flow communication with the interior filtered water chamber of the filter medium. The housing is configured to provide filtered water to a reservoir outlet. A housing cap is positioned at the first end of the housing and defines a channel fluidly connecting the unfiltered water chamber to the reservoir. A one-way valve is positioned within the channel, the one-way valve being configured to prevent fluid flow from the reservoir to the unfiltered water chamber. A valve screen is positioned between the one-way valve and the unfiltered water chamber, the valve screen being configured to filter unfiltered water passing from the unfiltered water chamber through the one-way valve to the reservoir.

In another exemplary embodiment, a beverage dispenser is provided. The beverage dispenser includes a dispenser; a hot water chamber for providing the dispenser with heated water; a reservoir; and a water filter assembly. The reservoir defines a reservoir outlet and includes a fitting attached to the reservoir and at least partially surrounding the reservoir outlet, the reservoir outlet being fluidly connected to the hot water chamber for providing water to the hot water chamber. The water filter assembly defines an axial direction and a radial direction and includes a filter medium extending along the axial direction and defining an interior filtered water chamber, the filter medium configured to filter water flowing inward generally along the radial direction into the interior filtered water chamber. The water filter assembly also includes a housing extending along the axial direction between a first end and a second end and enclosing the filter medium, the housing and the filter medium defining an unfiltered water chamber between the housing and the filter medium, the housing additionally defining an inlet in flow communication with the unfiltered water chamber proximate to the second end for receipt of unfiltered water from the reservoir, the housing further defining a housing outlet in flow communication with the interior filtered water chamber of the filter medium, the housing configured to provide filtered water to the reservoir outlet. The water filter assembly also includes a housing cap positioned at the first end of the housing and defining a vent channel fluidly connecting the unfiltered water chamber to the reservoir. The water filter assembly also includes a valve assembly positioned adjacent the vent channel, the valve assembly including a check valve being configured to prevent fluid flow from the reservoir to the unfiltered water chamber and a valve screen positioned between the check valve and the unfiltered water chamber to filter unfiltered water passing from the unfiltered water chamber through the valve assembly to the reservoir.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front, perspective view of a beverage dispenser according to an exemplary embodiment of the present subject matter.

FIG. 2 provides a schematic diagram of a portion of the exemplary beverage dispenser of FIG. 1.

FIG. 3 provides a perspective view of a water filter assembly in accordance with an exemplary embodiment of the present disclosure.

FIG. 4 provides a cross-sectional view of the exemplary water filter assembly of FIG. 3.

FIG. 5 provides a close up, perspective view of a housing cap of the exemplary water filter assembly of FIG. 3.

FIG. 6 provides a cross-sectional view of the housing cap of the exemplary water filter assembly of FIG. 3 taken along Line 6-6 of FIG. 5, with the filter media removed for clarity.

FIG. 7 provides a perspective cross-sectional view of the housing cap of the exemplary water filter assembly of FIG. 3 taken along Line 6-6 of FIG. 5, with the filter media removed for clarity.

FIG. 8A provides a perspective view of a valve screen assembly according to an exemplary embodiment of the present disclosure.

FIG. 8B provides another perspective view of the exemplary valve screen assembly of FIG. 8A.

FIG. 8C provides a cross-sectional view of the exemplary valve screen assembly of FIG. 8A taken along Line 8C-8C of FIG. 8A.

FIG. 9A provides a perspective view of a one-way valve with an integral valve screen according to an exemplary embodiment of the present disclosure.

FIG. 9B provides a cross-sectional view of the exemplary one-way valve of FIG. 9A taken along Line 9B-9B of FIG. 9A.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

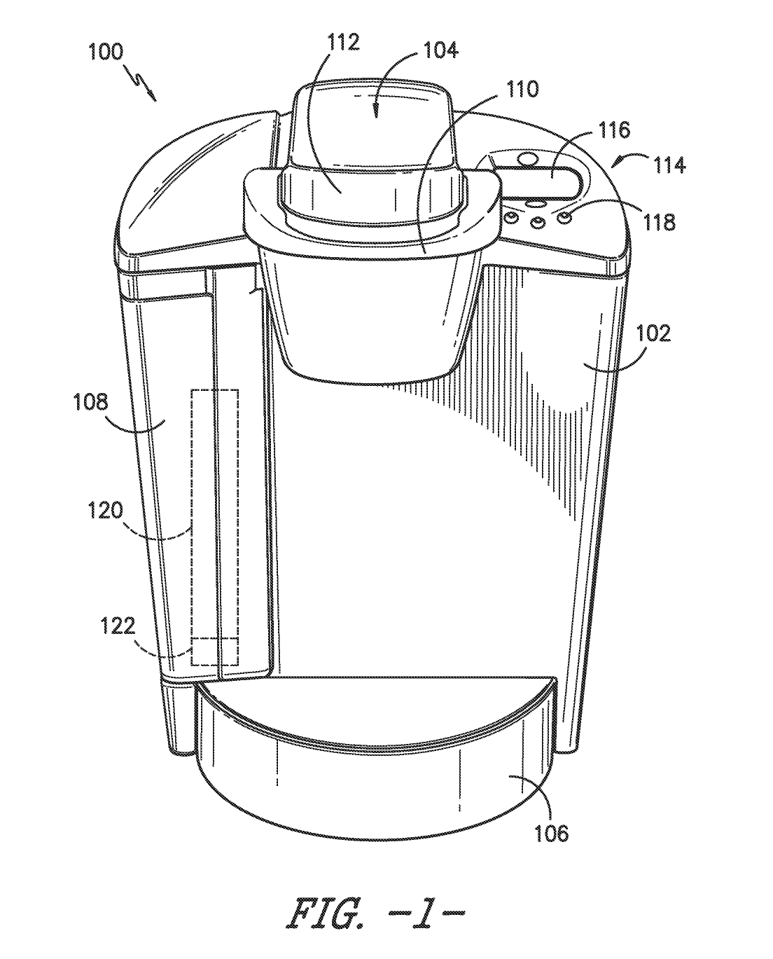

FIG. 1 provides a front, perspective view of a beverage dispenser 100 according to an exemplary embodiment of the present subject matter. Beverage dispenser 100 is generally referred to as a “single serve beverage dispenser 100” and receives capsules or pods with flavorings therein that are brewed or mixed with hot or cold water to provide a hot or cold beverage, as desired. As an example, beverage dispenser 100 may be a KEURIG® brand single-cup coffee brewing system or a VERISMO™ brand single-cup coffee brewing system. However, beverage dispenser 100 may alternatively be any other suitable beverage dispenser.

As may be seen in FIG. 1, beverage dispenser 100 includes a body 102, a dispenser portion 104, a pan or tray 106, and a reservoir 108. A lever 110 is provided with dispenser portion 104 to allow a user to open a lid 112 of dispenser portion 104 and access a receptacle (not shown) for receiving a capsule or pod. During brewing or mixing operations, water may be taken from the reservoir 108, heated or cooled, and provided to dispenser portion 104, wherein dispenser portion 104 either brews or mixes the water with the contents of the capsule or pod to provide a desired beverage. The beverage may be dispensed into a cup or mug (not shown) placed on tray 106 by a user. The exemplary beverage dispenser 100 also includes a control panel 114 including a display 116 and a plurality of user inputs 118 allowing the user to control operation of beverage dispenser 100.

It should be appreciated, however, that the present disclosure is not limited to any specific beverage dispenser 100, and in other exemplary embodiments, beverage dispenser 100 may have any other suitable configuration. Indeed, the water filter assembly described below may be used in any appliance where fluid from a supply source must be filtered prior to use.

As will be explained in greater detail below, and as is depicted in phantom in FIG. 1, a water filter assembly 120 is positioned in reservoir 108 and attached to a fitting 122 of reservoir 108. Water filter assembly 120 is generally provided to remove contaminants and particles in the water in reservoir 108 through, e.g., mechanical filtration and/or absorption of such contaminants.

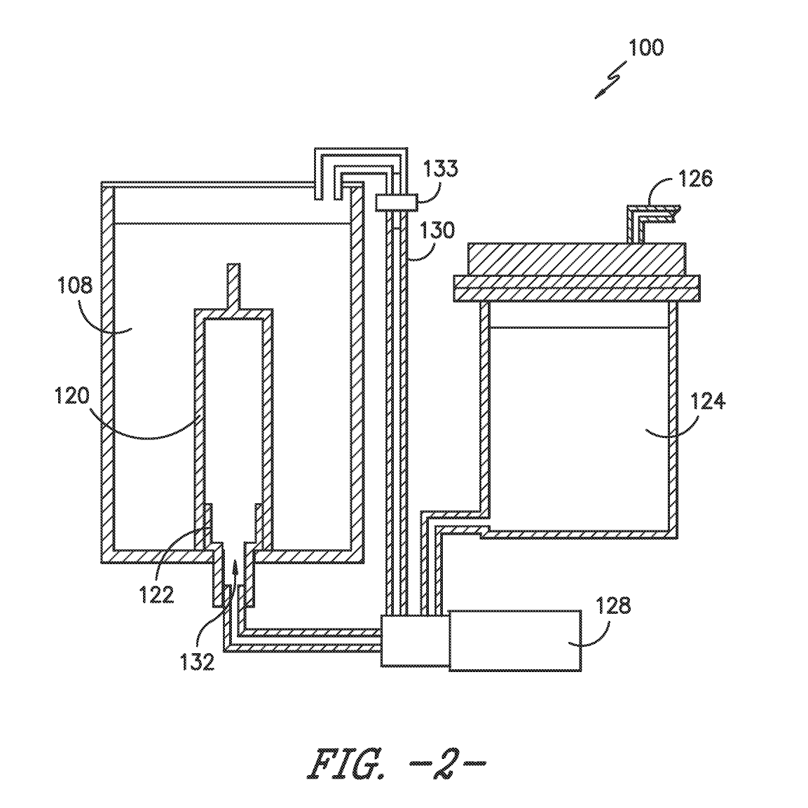

Referring now to FIG. 2, a schematic diagram is provided of a portion of the exemplary beverage dispenser 100 of FIG. 1. As is depicted, beverage dispenser 100 further includes a hot water chamber 124 and a pump 128. Hot water chamber 124 is configured to provide dispenser portion 104 with heated water via a conduit 126. Additionally, pump 128 is in flow communication with reservoir 108 and is configured to provide a flow of water from the reservoir 108 to the hot water chamber 124 when activated. Pump 128 may be a centrifugal pump, or alternatively may be any other suitable pump.

A priming vent 130 is provided in flow communication with the pump 128 and the reservoir 108 for providing a flow of water from the pump 128 to the reservoir 108 during a priming operation of the pump 128. More particularly, priming vent 130 is provided to allow a pump head (not shown) of the pump 128 to flood with water during priming operations.

Moreover, as schematically depicted, water filter assembly 120 is positioned in reservoir 108 and attached to fitting 122 in reservoir 108. More particularly, reservoir 108 defines an outlet 132 fluidly connected to hot water chamber 124 via pump 128 for providing water to the hot water chamber 124. During operation of the beverage dispenser 100, pump 128 may pull water from reservoir 108, through water filter assembly 120, and provide such water to the hot water chamber 124. Water from the hot water chamber 124 may then be provided to dispenser portion 104, wherein such water may be brewed or mixed with contents of any capsules or pods positioned therein. As previously discussed, the desired beverage may then be dispensed via dispenser portion 104 to a user.

During operation, if a pressure drop across water filter assembly 120 is greater than a certain threshold, fluid may be pulled from priming vent 130 as opposed to reservoir 108. The fluid may initially be water, however, it may also include air. If such fluid is allowed to be so pulled from priming vent 130 to pump 128 such that air is provided to pump 128, the air may cause pump 128 to cavitate and not operate properly. Accordingly, in certain exemplary embodiments of the present disclosure, beverage dispenser 100 may further include a one-way valve 133 positioned in priming vent 130 for preventing a flow of fluid in a flow direction away from reservoir 108 through priming vent towards pump 128. One-way valve 133 may have any suitable configuration. Inclusion of one-way valve 133 may allow for proper operation of beverage dispenser 100, or more particularly proper operation of pump 128, regardless of a pressure drop across water filter assembly 120 greater than a certain threshold.

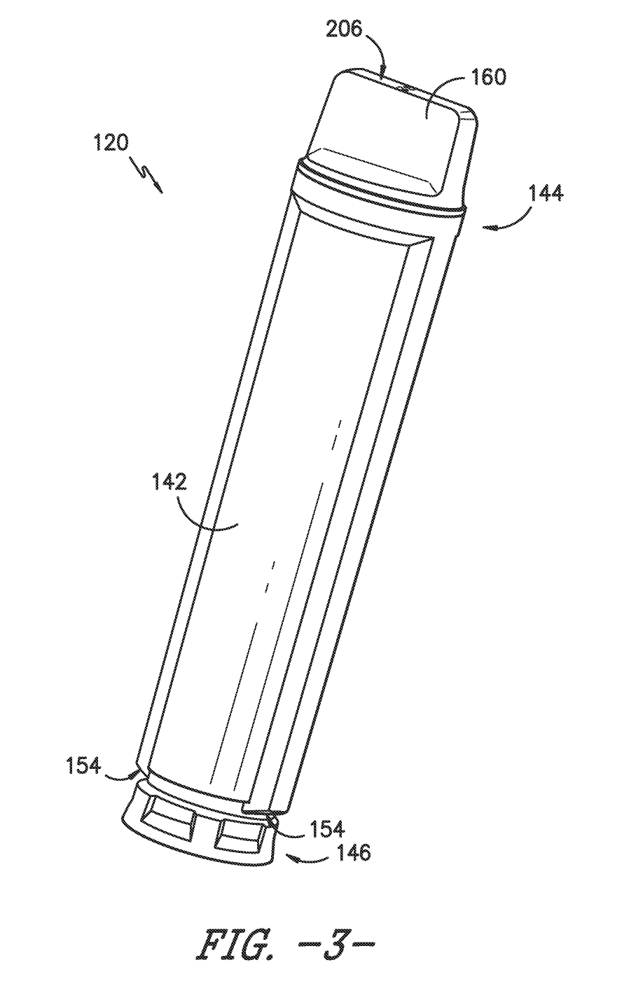

Referring now to FIGS. 3 and 4, water filter assembly 120 is illustrated in accordance with an exemplary embodiment of the present disclosure. More particularly, FIG. 3 provides a perspective view of water filter assembly 120 in accordance with an exemplary embodiment of the present disclosure, and FIG. 4 provides a cross-sectional view of the exemplary water filter assembly 120 of FIG. 3. As best shown in FIG. 4, water filter assembly 120 defines an axial direction A and a radial direction R. In certain embodiments, the axial direction A of water filter assembly 120 may be aligned with a vertical direction, however in other embodiments, water filter assembly 120 may be aligned in any other suitable orientation.

Water filter assembly 120 includes a filter medium 134 extending along the axial direction A between a first end 136 and a second end 138—filter medium 134 defining interior filtered water chamber 140. For the embodiment depicted, filter medium 134 is a cylindrical filter medium configured to filter water flowing inward generally along the radial direction R. Filter medium may be an activated carbon block, a pleated polymer sheet, a spun cord material, a melt blown material, one or more layers of fine mesh, or any other material suitable for filtering contaminants from a flow of fluid. According to the illustrated embodiment, filter medium 134 is, for example, an activated carbon block shaped in the form of a hollow cylinder. However, in other embodiments, filter medium 134 may be formed of any other suitable material.

Filter medium 134 is enclosed by a housing 142 also extending along the axial direction A between a first end 144 and a second end 146. More particularly, filter medium 134 is enclosed by a body portion 148 of housing 142 defining a generally cylindrical shape extending along the axial direction A. First end 144 of housing 142 is positioned proximate to first end 136 of filter medium 134 and second end 146 of housing 142 is positioned proximate to second end 138 of filter medium 134. Housing 142 and filter medium 134 together define an unfiltered water chamber 150 between the housing 142 and filter medium 134. For the embodiment depicted, the unfiltered water chamber 150 includes a generally annular chamber between body portion 148 and filter medium 134, as well as a volume above filter medium 134 at first end 144 of housing 142 and first end 136 of filter medium 134.

Body portion 148 of housing 142 additionally defines one or more inlets 154 proximate to second end 146 of housing 142 for receipt of unfiltered water from, e.g., reservoir 108. More particularly, housing 142 defines a channel 152, with the inlets 154 defined at an end of the channel 152 proximate to second end 146 of housing 142. Inlets 154 may provide flow communication between reservoir 108 and unfiltered water chamber 150. In this manner, unfiltered water may flow into housing 142 from reservoir 108 through inlets 154 and may fill the entire unfiltered water chamber 150.

In alternative embodiments, housing 142 may further include a siphon tube that extends from a location proximate to second end 146 of housing 142 to a location proximate first end 144 of housing 142 to provide unfiltered water to the unfiltered water chamber 150 at a location proximate to first end 144 of housing 142. Such a configuration may allow for a relatively high-performance filtering of water in reservoir 108 while minimizing a pressure drop across water filter assembly 120. More particularly, with such a configuration, unfiltered water is provided to first end 136 of filter medium 134 and may saturate substantially all of a surface area of filter medium 134 by filling unfiltered water chamber 150 from a top end.

Although the above-described embodiments describe inlets 154 positioned proximate second end 146, one skilled in the art will appreciate that other configurations may use any number of inlets positioned anywhere on housing 142. Indeed, inlets may be configured in any manner suitable for filling unfiltered water chamber 150 with fluid.

Referring specifically to FIG. 4, a first filter cap 158 is positioned over first end 136 of filter medium 134 to cover interior filtered water chamber 140 of filter medium 134. First filter cap 158 may be attached to first end 136 of filter medium 134 in any suitable manner. For example, first filter cap 158 may be attached to first end 136 of filter medium 134 using a glue or other suitable epoxy. Notably, first filter cap 158 may seal interior filtered water chamber 140 from unfiltered water chamber 150 at first end 136 of filter medium 134. Accordingly, unfiltered water provided to unfiltered water chamber 150 must flow inwardly along the radial direction R through filter medium 134 to reach interior filtered water chamber 140.

Housing 142 further includes a housing cap 160 positioned at first end 144 of housing 142 covering body portion 148 of housing 142. In certain embodiments, housing cap 160 may be attached to body portion 148 of water filter assembly 120 using an interference fit and/or a spin welding attachment method. However, in other embodiments, housing cap 160 may be attached to body portion 148 using any other suitable attachment means or mechanism to form a hermetic seal. Alternatively, in still other embodiments one or more portions of housing cap 160 may be formed integrally with body portion 148.

Water filter assembly 120 further includes a second filter cap 162 positioned at second end 138 of filter medium 134. Second filter cap 162 is configured for sealing second end 138 of filter medium 134 to housing 142. More particularly, second filter cap 162 includes a flange 164 extending outwardly along the radial direction R. Similarly, second end 146 of housing 142 includes a corresponding flange 166 extending inwardly along the radial direction R. Flange 164 of second filter cap 162 is positioned between the second end 146 of filter medium 134 and flange 166 of second end 138 of housing 142.

In certain embodiments, flange 164 of second filter cap 162 may be attached to second end 138 of filter medium 134 and/or flange 166 of second end 146 of housing 142 using a glue or any other suitable epoxy. Additionally, or alternatively, flange 164 of second filter cap 162 may be attached to second end 138 of filter medium 134 and/or flange 166 of second end 146 of housing 142 by applying a grease. Moreover, it should be appreciated, that in still other embodiments, flange 164 of second filter cap 162 may be attached to second end 138 of filter medium 134 and/or flange 166 of second end 146 of housing 142 in any other suitable manner, or alternatively may not be attached and instead one or more of the various components may be sealed by designing water filter assembly 120 with relatively close tolerances.

Referring now particularly to FIG. 4, housing cap 160 may include one or more one-way valves to control the flow of fluids between reservoir 108, unfiltered water chamber 150, and interior filtered water chamber 140. During certain events, air may make its way into one or both of interior filtered water chamber 140 and unfiltered water chamber 150. For example, air may be present in one or both of interior filtered water chamber 140 and unfiltered water chamber 150 when water filter assembly 120 is first installed in reservoir 108 or when the water level in reservoir 108 decreases. However, to ensure proper operation of beverage dispenser 100, it is generally beneficial for interior filtered water chamber 140 and unfiltered water chamber 150 to be completely filled with water.

Accordingly, first filter cap 158 may include a one-way valve 180 allowing air and fluid from interior filtered water chamber 140 to flow into unfiltered water chamber 150. For the embodiment depicted, one-way valve 180 is configured as a ball check valve. More specifically, one-way valve 180 includes an inverse frustoconical opening with a bottom hole defined adjacent to interior filtered water chamber 140 and a top hole positioned adjacent to unfiltered water chamber 150. A ball 182 is positioned in one-way valve 180 and is configured to cover the bottom hole to prevent fluid from traveling from unfiltered water chamber 150 to interior filtered water chamber 140. Additionally, ball 182 is configured to move upwards in response to a pressure differential greater than a predetermined amount across one-way valve 180—i.e., when a pressure in interior filtered water chamber 140 is more than a predetermined amount greater than a pressure in unfiltered water chamber 150—such that fluid may flow around ball 182 and into unfiltered water chamber 150.

Notably, ball 182 is not biased towards resting against the bottom hole (i.e., a closed position) other than by any force on ball 182 exerted by gravity. The predetermined amount of pressure differential for ball 182 to move up in certain exemplary embodiments may accordingly be relatively low. For example, in certain embodiments, ball 182 may be configured to move upwards when the pressure differential is less than or equal to one inch of water pressure. Additionally, for the embodiment depicted, ball 182 may be formed of a non-buoyant elastomeric material. However, in other exemplary embodiments, ball 182 may be formed of any other suitable material and the pressure differential may be any other suitable pressure differential.

In general, one-way valve 180 assists in evacuating air trapped in filtered water chamber 140, e.g., when it is first installed in reservoir 108. One-way valve 180 may be particularly beneficial when air becomes trapped inside interior filtered water chamber 140 after the filter medium 134 is wetted, e.g., when water filter assembly 120 is installed, removed, and reinserted into reservoir 108, or after the reservoir 108 is emptied. When this occurs, air trapped inside interior filtered water chamber 140 may not evacuate completely because a wet filter medium 134 provides more flow resistance than a dry filter medium 134.

As is also depicted in FIG. 4 housing cap 160 may similarly include a one-way valve 184 (details not shown) that is configured in substantially the same manner as one-way valve 180 in first filter cap 158. In this manner, one-way valve 184 allows air and fluid to travel from unfiltered water chamber 150 to reservoir 108, but prevents air or water from entering unfiltered water chamber 150 from reservoir 108 through housing cap 160. Therefore, as water filter assembly 120 is submerged, water may fill the entire unfiltered water chamber 150 and interior filtered water chamber 140, thereby displacing all air within housing 160, which may be evacuated through one-way valve 184. Then, one-way valve 184 acts as a seal to provide suction and prevent housing 160 from draining as the water level in reservoir 108 is lowered. Therefore, the water level may drop all the way to inlet 154 positioned near the bottom of reservoir 108, but the water filter assembly 120 remains substantially filled with water.

By filling the entire unfiltered water chamber 150 with water, substantially all of the surface area of filter medium 134 may be utilized, and a pressure drop across water filter assembly 120 may remain within an acceptable limit of beverage dispenser 100. Moreover, such a configuration provides for utilization of substantially all of the surface area of filter medium 134 regardless of a water level in reservoir 108. Accordingly, substantially all of the surface area of filter medium 134 may be utilized even when a water level in reservoir 108 is below first end 144 of housing 142 and first end 136 of filter medium 134. It should be appreciated, that as used herein, terms of approximation, such as “substantially” and “approximately,” refer to being within a ten percent margin of error.

Although the one-way valves 180, 184 described above are ball check valves, one skilled in the art will appreciated that many other types and configurations of one-way valves are possible and within the scope of the present subject matter. For example, in alternative embodiments, one or more of one-way valve 184 in housing cap 160 and one-way valve 180 in first filter cap 158 may be configured as an umbrella type one-way valve, a duckbill type one-way valve, or any other suitable one-way valve.

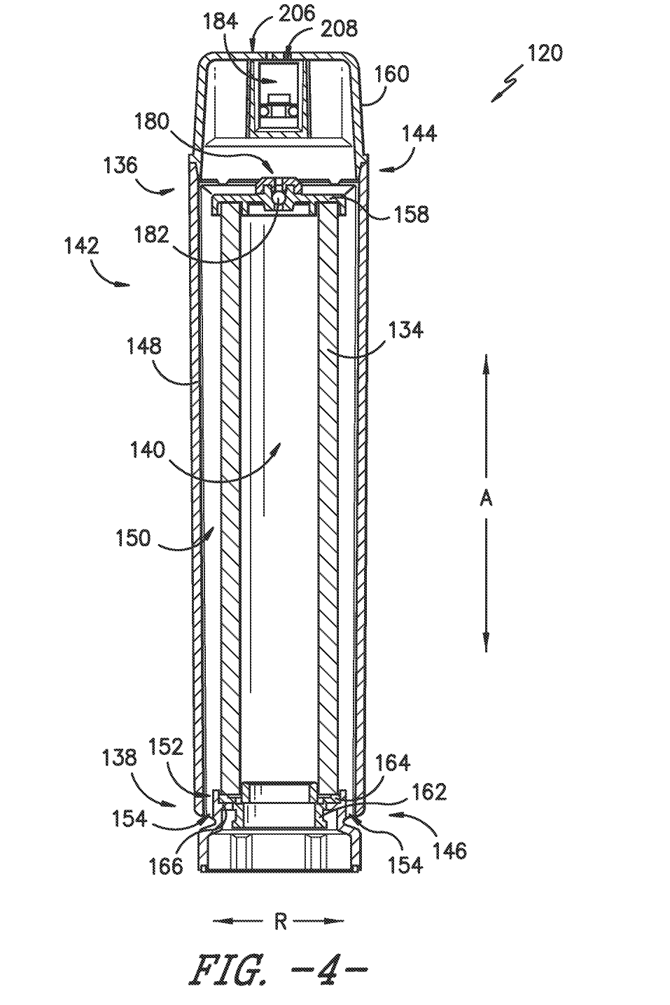

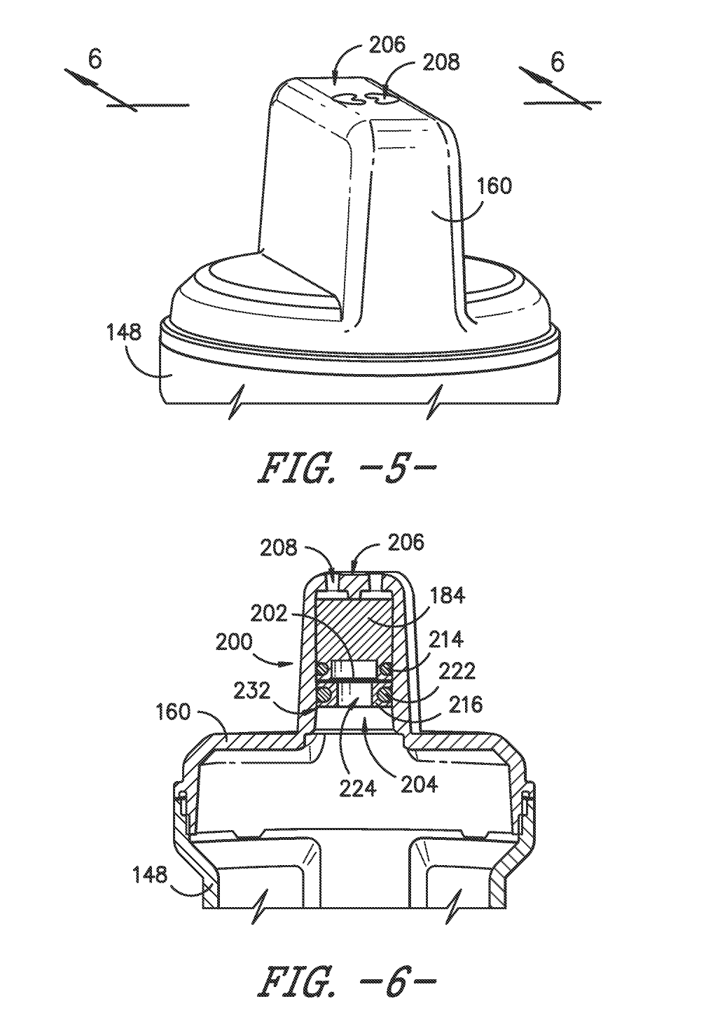

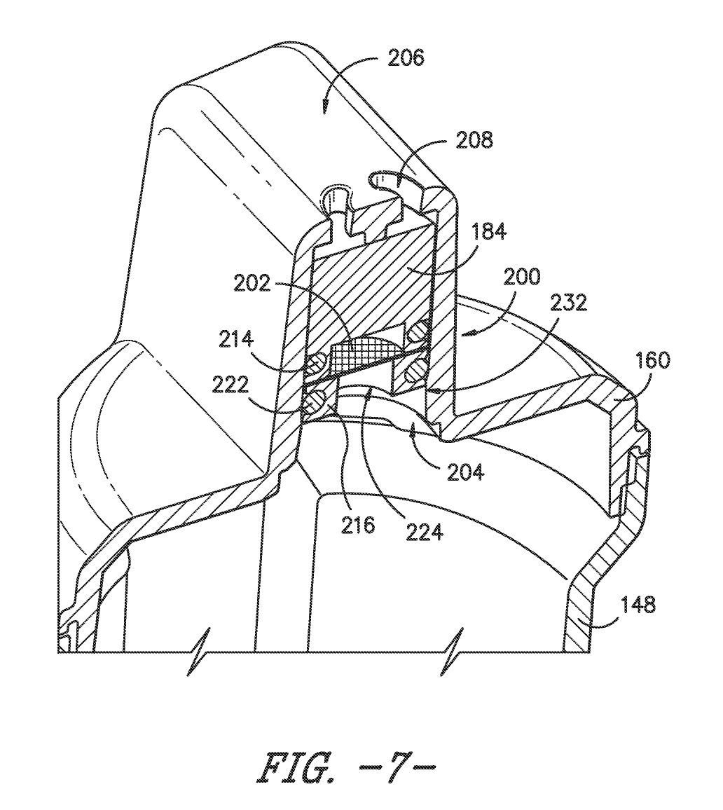

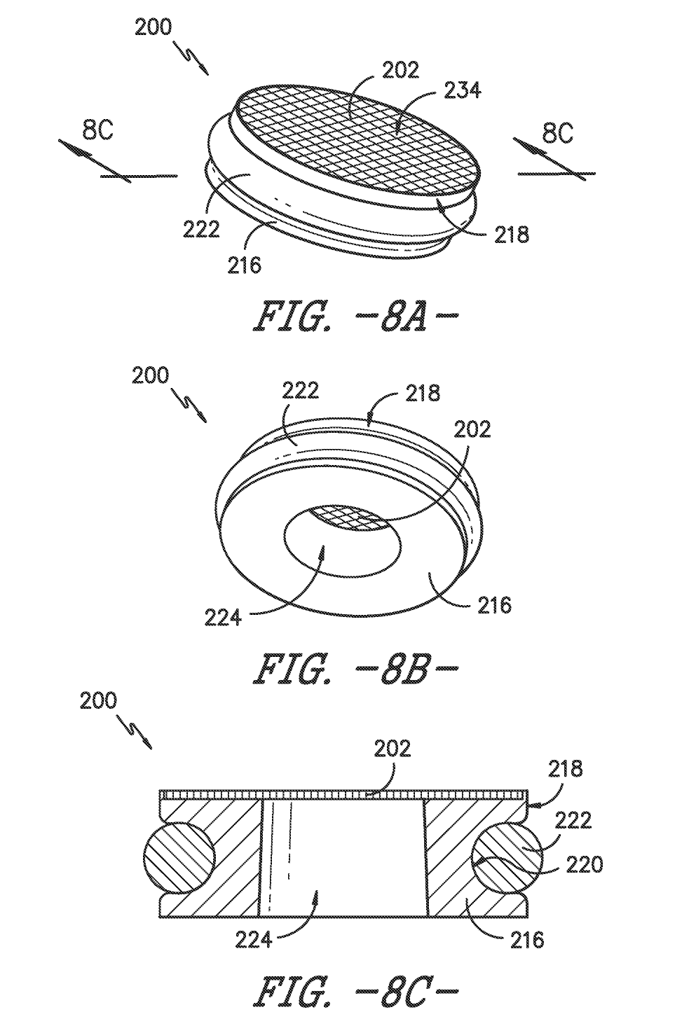

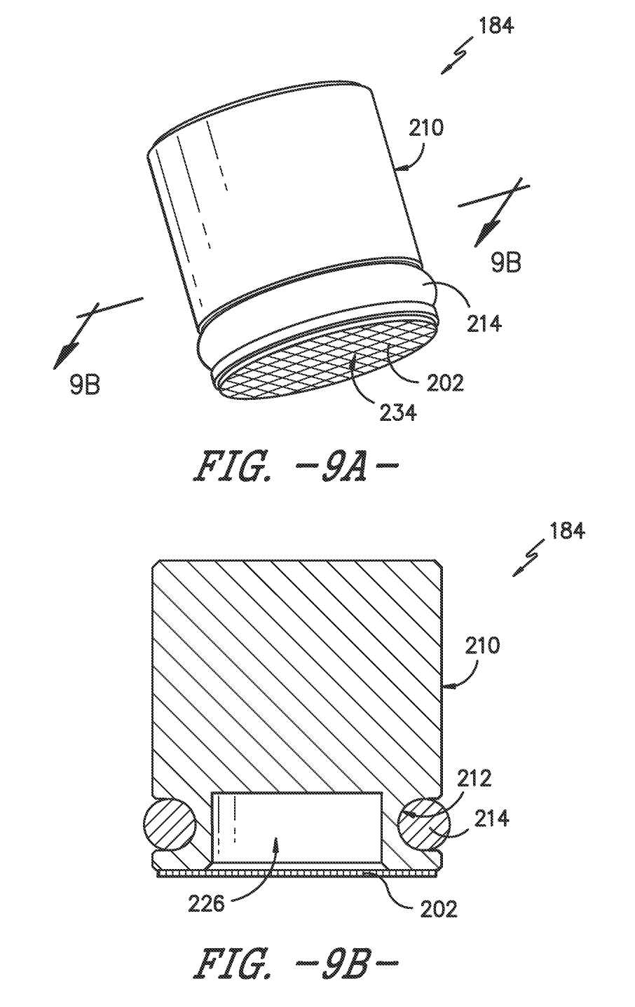

Referring now generally to FIGS. 4 through 9, aspects of the present invention will be described. More specifically, FIG. 4 provides a cross-sectional view of an exemplary water filter assembly and FIG. 5 provides a close up, perspective view of a housing cap. FIGS. 6 and 7 provide close up cross-sectional views of first end of housing and housing cap with filter medium and first filter cap removed for clarity in describing particular aspects of the water filter assembly 120 and housing cap. FIGS. 8 and 9 illustrate exemplary embodiments of valve screen assemblies described in detail below.

As shown in FIGS. 4 through 6, housing 142 may further include a valve screen assembly 200. Valve screen assembly 200 may further comprise a valve screen 202 positioned between one-way valve 184 and unfiltered water chamber 150 which is configured to filter unfiltered water passing from unfiltered water chamber 150 through one-way valve 184 to the reservoir 108. Valve screen assembly 200 may be disposed in a channel 204 defined by housing cap 160. More specifically, channel 204 may be a substantially cylindrical channel extending between an upstream end positioned in unfiltered water chamber 150 to a downstream end positioned proximate a top surface 206 of housing cap 160. Housing cap 160 may further define one or more vent apertures 208 in top surface 206, and downstream end of channel 204 may be in fluid communication with vent apertures 208, thereby fluidly connecting unfiltered water chamber 150 to reservoir 108.

Valve screen assembly 200 may be disposed upstream of one-way valve 184 such that valve screen 202 filters any fluid flowing through one-way valve 184. More particularly, valve screen 202 may remove any debris, sediment, or contaminants in the water or air flowing from unfiltered water chamber 150 through one-way valve 184 to reservoir 108 before the water reaches one-way valve 184. Removing sediment and contaminants upstream of one-way valve 184 is particularly advantageous because foreign materials carried in water or air through one-way valve 184 can prevent it from operating effectively by interfering with the sealing surface. For example, when one-way check valve 184 is a simple check valve with a flap that forms a seal with a sealing surface when reverse flow occurs, contaminants that have built-up or become attached to the sealing surface may prevent the flap from forming a proper seal. When this occurs, fluid may flow around the flap in both directions, thus defeating the purpose of one-way check valve 184.

According to the illustrated embodiment described above, one-way valve 184 may be positioned within channel 204, such that it is configured to prevent fluid flow from reservoir 108 to unfiltered water chamber 150. To prevent air or water from flowing from reservoir 108 around the sides of one-way valve 184, an outer surface 210 of one-way valve 184 may define an annular indentation 212 (FIG. 9B) that may receive a seal 214, e.g., an O-ring. However, according to alternative embodiments, channel 204 may not be needed for operation. Instead, one-way valve 184 may be installed and sealed directly over vent apertures 208 of housing cap 160. Other configurations are also possible. Indeed, any manner of positioning a one-way valve between unfiltered water chamber 150 and reservoir 108 to prevent reverse flow from reservoir 108 may be within the scope of the present subject matter.

According to the exemplary embodiment illustrated in FIGS. 6 through 8, valve screen assembly 200 includes valve screen 202 which may be attached to a hollow cylinder 216. Hollow cylinder 216 may have an outer surface 218 defining an annular indentation 220 configured to receive a seal 222 that extends circumferentially around outer surface 218. Seal 222 may provide a seal between hollow cylinder 216 and channel 204 when hollow cylinder 216 is inserted into channel 204 as described below. In this manner, seal 222 prevents unfiltered water from flowing around the sides of valve screen assembly 200, instead forcing all air and water through a hollow center 224 of hollow cylinder 216, and thus through valve screen 202, which covers hollow center 224.

Hollow cylinder 216 may be made from any suitably rigid material that may be configured to receive seal 222 and valve screen 202 as described above. For example, hollow cylinder 216 may be made of plastic, and may be injection molded to the desired size and shape. Valve screen 202 may be attached after hollow cylinder 216 is constructed using a suitable adhesive, mechanical fasteners, or another method of attaching valve screen 202. Alternatively, according to the illustrated embodiment, valve screen 202 may be integrally molded into hollow cylinder 216. This may be achieved, for example, by pressing valve screen 202 onto hollow cylinder 216 while it is not fully hardened and is still malleable. In this manner, plastic from hollow cylinder 216 may flow into the mesh of valve screen 202 and create a mechanical bond upon hardening. According to some exemplary embodiments, valve screen 202 may be constructed of a material similar to hollow cylinder 216, or may have a similar coating, which when heated along with hollow cylinder 216 forms a chemical bond between valve screen 202 and hollow cylinder 216. Alternatively, valve screen 202 may simply be placed in the mold prior to injection molding hollow cylinder 216 to achieve suitable mechanical and/or chemical bonding. According to another alternative embodiment, hollow cylinder 216 may be made from a resilient material that may be pressed into channel 204 such that hollow cylinder 216 forms a seal with channel 204 even without the need of seal 222.

According to an alternative exemplary embodiment, valve screen 202 may be attached directly to one-way valve 184. More specifically, valve screen 202 may be attached to one-way valve 184 such that an inlet 226 of one-way valve 184 is covered by valve screen 202, such that water may only flow into one-way valve 184 through valve screen 202. Valve screen 202 may be attached to one-way valve 184 in the same manner described above for valve screen assembly 200. For example, valve screen 202 may be attached using an adhesive, a mechanical faster, or it may be integrally molded into one-way valve 184.

As described above and shown in FIGS. 9A and 9B, when valve screen 202 is attached directly to one-way valve 184, seal 214, which is similar to seal 222 of valve screen assembly 200, prevents fluid from escaping to reservoir 108 between the sides of one-way valve 184 and channel 204. One-way valve 184 may be installed in the same manner described above with respect to valve screen assembly 200. More specifically, one-way valve 184 may be pressed into channel 204 and may rely on the compression of seal 214 to secure it in place.

According to an exemplary embodiment, channel 204 may define a necked portion 232 having a smaller diameter than a nominal diameter of channel 204. In this manner, one-way valve 182 may be pushed into channel 204 past necked portion 232 to secure one-way valve 184 within channel 204. More specifically, as one-way valve 184 is pressed into channel 204, seal 214 is highly compressed. As one-way valve 184 is pushed upward and passes necked portion 232 of channel 204, the diameter of channel 204 increases, but seal 214 is still sufficiently compressed to form a seal between one-way valve 184 and channel 204. In this manner, any force commonly experienced during operation of beverage dispenser 100 that tends to push one-way valve 184 back through channel 204 will be insufficient to push one-way valve 184 past necked portion 232. Similarly, when valve screen 202 is part of a standalone valve screen assembly 200 having its own seal 222, valve screen assembly 200 may be pressed into channel 204 and secured in the same manner, thus locking both valve screen assembly 200 and one-way valve 184 in channel 204.

Valve screen 202 may be made from any material suitable for filtering fluids flowing from unfiltered water chamber 150 to reservoir 108. Valve screen 202 is typically a mesh screen having a plurality of openings 234 sized to prevent the passing of a particular size or type of sediment or contaminants. The material used for valve screen 202 is preferably rigid enough to maintain mesh geometry and capable of withstanding prolonged operation without degradation. According to an exemplary embodiment, valve screen 202 is made from a hydrophobic material. Hydrophobic materials are useful because they tend to repel water and decrease surface tension between openings 234 of the mesh when wetted, thus decreasing flow resistance. The size of openings 234 may vary depending on the application, but opening 234 sizes are typically less than 1/16 inch.

Notably, opening 234 sizes may depend on the material used. For example, according to one exemplary embodiment, valve screen 202 may be made of polypropylene and may preferably define mesh openings 234 that are approximately 0.0041 inches wide. According to another exemplary embodiment, valve screen 202 may be made of Teflon-coated stainless steel and may define mesh openings 234 that are approximately 0.0014 inches wide. Other valve screen 202 materials may be used and different mesh size openings 234 are possible. In addition, mesh size openings 234 may be non-uniform over valve screen 202 and may be square, circular, oblong, or any other size suitable for filtering particulates.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. A water filter assembly for a beverage dispenser having a reservoir, the water filter assembly defining an axial direction and a radial direction and comprising:
a filter medium extending along the axial direction and defining an interior filtered water chamber, the filter medium configured to filter water flowing inward generally along the radial direction into the interior filtered water chamber;
a housing extending along the axial direction between a first end and a second end and enclosing the filter medium, the housing and the filter medium defining an unfiltered water chamber between the housing and the filter medium, the housing additionally defining an inlet in flow communication with the unfiltered water chamber proximate to the second end for receipt of unfiltered water from the reservoir, the housing further defining a housing outlet in flow communication with the interior filtered water chamber of the filter medium, the housing configured to provide filtered water to a reservoir outlet;
a housing cap positioned at the first end of the housing and defining a channel fluidly connecting the unfiltered water chamber to the reservoir;
a one-way valve positioned within the channel, the one-way valve being configured to prevent fluid flow from the reservoir to the unfiltered water chamber; and
a valve screen positioned between the one-way valve and the unfiltered water chamber, the valve screen being configured to filter unfiltered water passing from the unfiltered water chamber through the one-way valve to the reservoir.

2. The water filter assembly of claim 1, wherein the valve screen is attached to a hollow cylinder, the hollow cylinder having an outer surface defining an annular indentation configured to receive a seal that extends circumferentially around the outer surface to provide a seal between the hollow cylinder and the channel.

3. The water filter assembly of claim 2, wherein the hollow cylinder is made of plastic, and the valve screen is integrally molded into the hollow cylinder.

4. The water filter assembly of claim 1, wherein the valve screen is made of polypropylene.

5. The water filter assembly of claim 4, wherein the valve screen defines a plurality of openings that are approximately 0.0041 inches wide.

6. The water filter assembly of claim 1, wherein the valve screen is made of Teflon-coated stainless steel.

7. The water filter assembly of claim 6, wherein the valve screen defines a plurality of openings that are approximately 0.0014 inches wide.

8. The water filter assembly of claim 1, wherein the valve screen is attached directly to the one-way valve to cover an inlet of the one-way valve.

9. The water filter assembly of claim 8, wherein the valve screen is attached to the one-way valve using an adhesive.

10. The water filter assembly of claim 8, wherein the one-way valve comprises an annular indentation configured to receive a seal that extends circumferentially around the one-way valve to provide a seal between the one-way valve and the channel.

11. The water filter assembly of claim 8, wherein the channel defines a necked portion having a smaller diameter than a nominal diameter of the channel, such that one-way valve may be pushed into the channel past the necked portion to secure the one-way valve within the channel.

12. The water filter assembly of claim 8, wherein the valve screen is made from a hydrophobic material.

13. The water filter assembly of claim 12, wherein the valve screen has a mesh opening size of less than 1/16 inch.

14. A beverage dispenser comprising:
a dispenser;
a hot water chamber for providing the dispenser with heated water;
a reservoir defining a reservoir outlet and including a fitting attached to the reservoir and at least partially surrounding the reservoir outlet, the reservoir outlet being fluidly connected to the hot water chamber for providing water to the hot water chamber; and
a water filter assembly defining an axial direction and a radial direction and comprising:
a filter medium extending along the axial direction and defining an interior filtered water chamber, the filter medium configured to filter water flowing inward generally along the radial direction into the interior filtered water chamber;
a housing extending along the axial direction between a first end and a second end and enclosing the filter medium, the housing and the filter medium defining an unfiltered water chamber between the housing and the filter medium, the housing additionally defining an inlet in flow communication with the unfiltered water chamber proximate to the second end for receipt of unfiltered water from the reservoir, the housing further defining a housing outlet in flow communication with the interior filtered water chamber of the filter medium, the housing configured to provide filtered water to the reservoir outlet;
a housing cap positioned at the first end of the housing and defining a vent channel fluidly connecting the unfiltered water chamber to the reservoir; and
a valve assembly positioned adjacent the vent channel, the valve assembly comprising a check valve being configured to prevent fluid flow from the reservoir to the unfiltered water chamber and a valve screen positioned between the check valve and the unfiltered water chamber to filter unfiltered water passing from the unfiltered water chamber through the valve assembly to the reservoir.

15. The beverage dispenser of claim 14, wherein the valve screen is attached to a hollow cylinder, the hollow cylinder having an outer surface defining an annular indentation configured to receive a seal that extends circumferentially around the outer surface to provide a seal between the hollow cylinder and the vent channel.

16. The beverage dispenser of claim 15, wherein the hollow cylinder is made of plastic, and the valve screen is integrally molded into the hollow cylinder.

17. The beverage dispenser of claim 14, wherein the valve screen is attached directly to the check valve to cover a check valve inlet, and the check valve comprises an annular indentation configured to receive a seal that extends circumferentially around the check valve to provide a seal between the check valve and the vent channel.

18. The beverage dispenser of claim 14, wherein the vent channel defines a necked portion having a smaller diameter than a nominal diameter of the vent channel, such that check valve may be pushed into the vent channel past the necked portion to secure the check valve within the vent channel.

19. The beverage dispenser of claim 14, wherein the valve screen is made from a hydrophobic material.

20. The beverage dispenser of claim 19, wherein the valve screen has a mesh opening size of less than 1/16 inch.
